(19) United States
(12) Patent Application Publication
(10) Pub. No.: US 2009/0216539 A1
(43) Pub. Date: Aug. 27, 2009

(54) IMAGE CAPTURING DEVICE

(75) Inventor: HUNG-YUAN CHIANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/118,956

(22) Filed: May 12, 2008

(30) Foreign Application Priority Data
Feb. 22, 2008 (CN) 200810300383.9

(51) Int. Cl. G10L 21/00; H04N 5/225

(52) U.S. Cl. 704/275; 348/207.99; 704/E15.04; 704/E15.043; 348/E05.024

(57) ABSTRACT

An image capturing device includes a digital signal processor for processing an image captured by an imaging sensor, a display unit for displaying the image, a storage unit for storing the image and preset voice samples, and a voice processing unit for picking up sound waves and converting the sound waves into text information. Each voice sample represents a category. In a first operation mode, the digital signal processor assigns the image to the category if the text information approximately matches one of the voice samples, or establishes a new category and assigns the images to the new category if the text information does not match any of the voice samples. In a second operation mode, the digital signal processor causes the image in the category corresponding to the text information to be displayed by the display unit in a slideshow fashion or a thumbnail fashion.

### BACKGROUND

1. Field of the Invention

The present invention relates to imaging technology, and particularly, to an image capturing device.

2. Description of Related Art

Image capturing devices, such as digital still cameras and camcorders, are popular with consumers. In some cases, a consumer will purchase an image capturing device capable of storing hundreds of images due to a significant amount of internal memory or an added memory card. Under these circumstances, when the user attempts to find and view a particular image or a series of images, it can be difficult to find the image(s) amongst the hundreds of images.

### SUMMARY

The present invention relates to an image capturing device. The image capturing device includes a digital signal processor for processing an image captured by an imaging sensor, a display unit for displaying the image, a storage unit for storing the image and preset voice samples, and a voice processing unit for picking up sound waves, and converting the sound waves into text information. Each voice sample represents a category. When the digital signal processor operates in a first operation mode, the digital signal processor assigns the images to the corresponding category if the text information approximately matches one of the voice samples, or establishes a new category and assigns the images to the new category if the text information does not match any of the voice samples. In a second operation mode, the digital signal processor causes the image in the category corresponding to the text information to be displayed by the display unit in a slideshow fashion or a thumbnail fashion.

Other advantages and novel features of the present invention will become more apparent from the following detailed description of present embodiments when taken in conjunction with the accompanying drawings.

### BRIEF DESCRIPTION OF THE DRAWINGS

FIG. 1 is a function diagram of modules of an image capturing device in accordance with a present embodiment.

FIG. 2 is a flowchart of a categorizing process for the image capturing device of FIG. 1.

FIG. 3 is a flowchart of a search process for the image capturing device of FIG. 1.

### DETAILED DESCRIPTION OF THE EMBODIMENTS

Reference will now be made to the figures to describe the at least one present embodiment in detail.

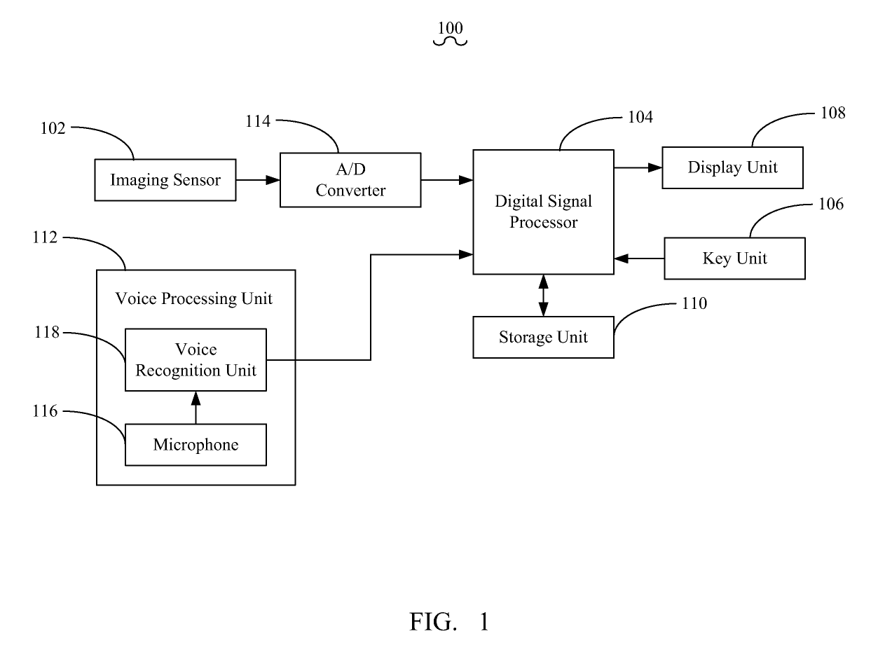

Referring to FIG. 1, an image capturing device 100 according to a present embodiment is shown. The image capturing device 100 includes an imaging sensor 102, a digital signal processor 104 (DSP), a key unit 106, a display unit 108, a storage unit 110, and a voice processing unit 112. The imaging sensor 102, such as a charge coupled device (CCD) sensor or a complementary metal-oxide semiconductor (CMOS) sensor is coupled to the DSP 104. The DSP 104 uses digital data, therefore an analog-to-digital (A/D) converter 114 is coupled between the imaging sensor 102 and the DSP 104. It is to be understood that the A/D converter 114 can be a stand-alone device coupled between the imaging sensor 102 and the DSP 104, or that the DSP 104 could have an onboard A/D converter to perform this function.

The key unit 106 includes a plurality of keys for a user to operate the image capturing device 100. The display unit 108 may be a liquid crystal display (LCD). Images captured by the imaging sensor 102 or stored in the storage unit 110 may be displayed by the LCD. The storage unit 110 can be an internal storage medium or an external storage medium of the image capturing device 100.

The voice processing unit 112 includes a microphone 116 for converting sound waves into electrical signals, and a voice recognition unit 118 for generating text information according to the electrical signals. When a user wants to categorize an image stored in the storage unit 110, the user presses one of the keys to activate the voice processing unit 112. The user speaks into the microphone 116, and the voice recognition unit 118 performs the function of converting spoken words of the user into text information. The DSP 104 receives the text information, and compares the text information with a plurality of voice samples preset in the storage unit 110. Each voice sample represents a category. If the text information approximately matches with one of the voice samples, the image is assigned to the corresponding category by the DSP 104. If the text information does not match any of the plurality of voice samples, the DSP 104 may establish a new category corresponding to the text information and store the new category in the storage unit 110. The image is then assigned to the new category. The categories may include relationships, e.g. “family”, “friend”, or “relative”, location, e.g. “Greece”, or “Disneyland”, festivals, e.g. “National Day”, or “Labor Day”, and so on. It is to be understood that the plurality of voice samples may be set in the storage unit 110 by a manufacturer, and can be modified and/or added to by users.

During categorization of the image, a category voice annotation is added to image data of the image, and saved in the storage unit 110, so that the assigned image can be identified when the user wants to find the images belonging to the category.

After the images are assigned categories and saved in the storage unit 110, if the user wants to find the images in one of the categories, such as all of the images assigned to the “family” category, he speaks “family” into the microphone 116. The DSP 104 receives the text information associated with the spoken word of the user from the voice recognition unit 118, reads the images in the “family” category from the storage unit 110, and the images may be displayed by the LCD in a slideshow fashion or a thumbnail fashion as selected by the user.

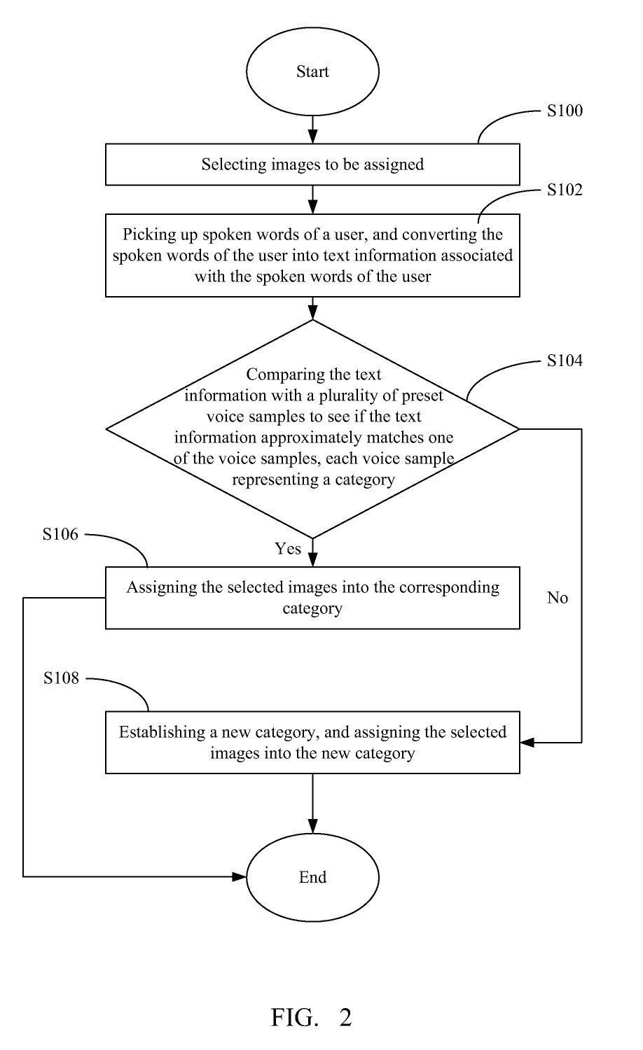

Referring to FIG. 2, a flowchart of a categorizing process for the image capturing device 100 is shown. The categorizing process includes selecting images to be assigned (S100), picking up spoken words of a user, and converting the spoken words of the user into text information associated with the spoken words of the user (S102), and comparing the text information with a plurality of preset voice samples to see if the text information approximately matches one of the voice samples, each voice sample representing a category (S104). If so, the selected images are assigned to the corresponding category (S106). If not, a new category is established, and the selected images are assigned to the new category (S108).

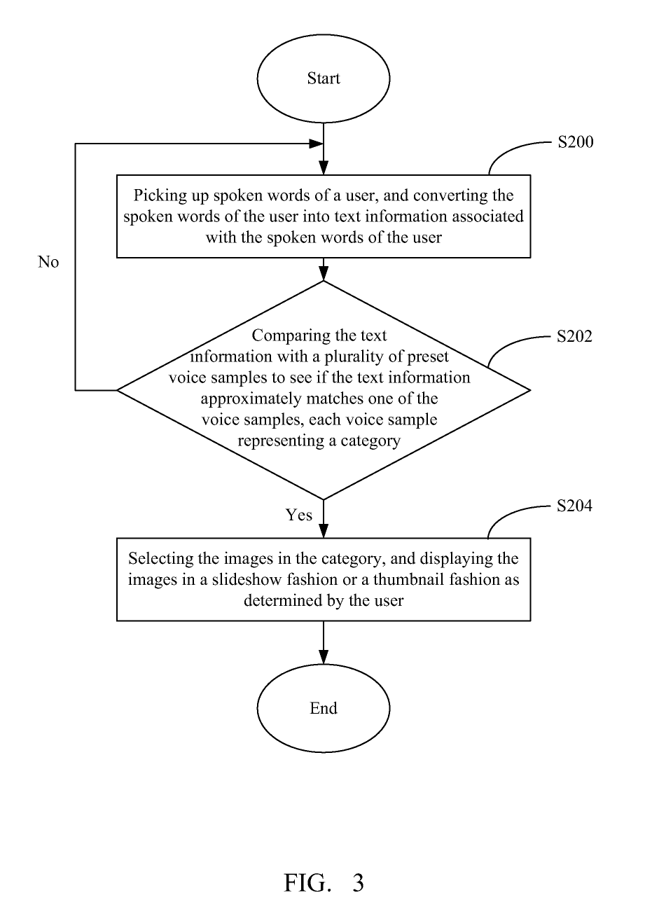

Referring to FIG. 3, a flowchart of a search process for the image capturing device 100 to display images assigned to a category is shown. The search process includes picking up spoken words of a user, and converting the spoken words of the user into text information associated with the spoken words of the user (S200), comparing the text information with a plurality of preset voice samples to see if the text information approximately matches one of the voice samples, each voice sample representing a category (S202). If so, selecting the images in the category, and displaying the images in a slideshow fashion or a thumbnail fashion as determined by the user (S204). If not, the search process returns to Step S200.

Since categories of the images are associated with spoken words of a user, a particular image or a series of images stored in the image capturing device 100 can be found easily by speaking the assigned word for the desired category.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An image capturing device comprising:
an imaging sensor for capturing an image;
a digital signal processor coupled to the image sensor for processing the image;
a display unit for displaying the image;
a storage unit for storing the image and a plurality of preset voice samples, each preset voice sample representing a category; and
a voice processing unit for picking up sound waves, and converting the sound waves into text information;
wherein when the digital signal processor operates in a first operation mode, the digital signal processor assigns the image to the category if the text information approximately matches one of the voice samples, or establishes a new category in the storage unit and assigns the image to the new category if the text information does not match any of the voice samples; and when the digital signal processor operates in a second operation mode, the digital signal processor causes the image assigned to the category corresponding to the text information to be displayed by the display unit in a slideshow fashion or a thumbnail fashion.

2. The image capturing device as claimed in claim 1, wherein the imaging sensor is one of a charge coupled device sensor and a complementary metal-oxide semiconductor sensor.

3. The image capturing device as claimed in claim 1, wherein an analog-to-digital converter is coupled between the imaging sensor and the digital signal processor.

4. The image capturing device as claimed in claim 1, wherein the display unit is a liquid crystal display.

5. The image capturing device as claimed in claim 1, wherein the voice processing unit includes a microphone for converting the sound waves into electrical signals, and a voice recognition unit for generating text information corresponding to the electrical signals.

6. The image capturing device as claimed in claim 1, further comprising a key unit for a user to operate the image capturing device.

7. A method of categorizing a digital image, the method comprising:
selecting the digital image;
receiving a voice signal;
converting the voice signal to text information; and
assigning the digital image to a category corresponding to the text information.

8. The method as claimed in claim 7, further comprising:
searching for an existing category matching the text information;
wherein assigning the digital image to the category corresponding to the text information is assigning the digital image to the existing category.

9. The method as claimed in claim 7, further comprising:
searching for an existing category matching the text information; and
creating a new category when no existing category matches the text information;
wherein assigning the digital image to the category corresponding to the text information is assigning the digital image to the new category.

10. A method of displaying a digital image assigned to a category, the method comprising:
receiving a voice signal;
converting the voice signal to text information; and
displaying the digital image when the text information matches the category.

11. The method as claimed in claim 10, further comprising:
performing a search to find the category based on the text information;
wherein displaying the digital image when the text information matches the category is displaying the digital image when the category is found during the search based on the text information.
